(19) United States
(12) Patent Application Publication
(10) Pub. No.: US 2026/0010455 A1
(43) Pub. Date: Jan. 8, 2026

(54) DEVICE AND METHOD WITH COMPUTING-SYSTEM PERFORMANCE SIMULATION

(71) Applicant: Samsung Electronics Co., Ltd., Suwon-si (KR)

(72) Inventors: Fengtao XIE, Xi'an (CN); Peng LIU, Xi'an (CN)

(73) Assignee: Samsung Electronics Co., Ltd., Suwon-si (KR)

(21) Appl. No.: 19/071,341

(22) Filed: Mar. 5, 2025

(30) Foreign Application Priority Data
Jul. 2, 2024 (CN) 202410884301.9
Oct. 30, 2024 (KR) 10-2024-0151092

(51) Int. Cl. G06F 11/34; G06F 12/084

(52) U.S. Cl. CPC G06F 11/3457; G06F 11/3419; G06F 12/084

(57) ABSTRACT

A method includes: converting a first task assigned to simulated hardware having a first configuration of a simulated computing system into a second task, where the first task requires a first scale and a first degree of parallelism and the second task requires a second scale that is equal to the first scale and a second degree of parallelism; obtaining a probability that the simulated hardware having the first configuration succeeds in a requested event by executing a simulation in which hardware having a second configuration processes the second task; and based on the probability, based on the first scale of the first task, and based on parameter information of the simulated hardware having the first configuration, predicting a statistical performance index of the simulated hardware having the first configuration when the simulated hardware having the first configuration processes the first task.

### CROSS-REFERENCE TO RELATED APPLICATIONS

This application claims the benefit under 35 USC § 119 (a) of Chinese Patent Application No. 202410884301.9, filed on Jul. 2, 2024, in the China National Intellectual Property Administration, and Korean Patent Application No. 10-2024-0151092, filed on Oct. 30, 2024, in the Korean Intellectual Property Office, the entire disclosures of which are incorporated herein by reference for all purposes.

### BACKGROUND

### 1. Field

The following description relates to a device and method with computing system performance simulation.

### 2. Description of Related Art

High-performance computing (HPC) and artificial intelligence (AI) applications may require the performance of large-scale computing systems for practical use. In a stage of designing and optimizing a computing system, performance of the computing system may be predicted by using a system simulator to simulate benchmarks in terms of scalability and degree of parallelism. The computing system design and optimization may be guided by simulated predicted performance of the computing system.

A hardware simulation of the computing system may be performed by using a simulation using a discrete event or by using a simulation based on an analysis model, discussed in turn next. In the case of a simulation using a discrete event, such a simulation uses time subdivision during the simulation process, and since a clock frequency is used for the time subdivision aspect of the simulation, the overall simulation efficiency may be low. Since the simulation time using the discrete event is greatly affected by factors such as the scalability and the degree of parallelism of the application, simulation using a discrete event may be suitable for simulating simple applications with a short execution time precisely on small-scale hardware. In the case of simulation based on an analysis model, such a simulation simulates and analyzes the computing system based on a theoretical analysis and mathematical model construction, so the simulation based on an analysis model may be suitable for quickly simulating complex applications with a long execution time on large-scale hardware. However, simulation based on an analysis model may mostly be feasible when there are particular hardware configurations, particular applications, and particular program inputs; such a simulation may not be practical when there are various applications, issues of different scales, and different degrees of parallelism.

The above description is information the inventor(s) acquired during the course of conceiving the present disclosure, or already possessed at the time, and is not necessarily art publicly known before the present application was filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a computing device for simulating a computing system includes: a memory storing instructions; and one or more processors configured to execute the instructions, wherein the instructions, when executed by the one or more processors, cause the computing device to: convert a first task assigned to simulated hardware having a first configuration of the simulated computing system into a second task, wherein the first task requires a first scale and a first degree of parallelism and the second task requires a second scale that is less than the first scale and a second degree of parallelism that is less than the first degree of parallelism; obtain a probability of the simulated hardware having the first configuration succeeding in a requested event, the obtaining performed by executing a simulation in which simulated hardware having a second configuration that is smaller than the simulated hardware having the first configuration processes the second task; and based on the probability, based on the first scale of the first task, and based on parameter information of the simulated hardware having the first configuration, predict a statistical performance index of the simulated hardware having the first configuration when the simulated hardware having the first configuration processes the first task.

The instructions, when executed by the one or more processors, may cause the computing device to: convert the simulated hardware having the first configuration into the simulated hardware having the second configuration, based on a conversion ratio of the second task to the first task; convert the first scale into the second scale; and convert the first degree of parallelism into the second degree of parallelism.

Based on the simulated hardware of the first and second configurations being a cache memory, the first configuration may include a size of a private cache of the cache memory, a size of a shared cache of the cache memory, and a size of the cache memory, and the second configuration may include the size of the private cache of the cache memory, the size of the shared cache of the cache memory, a converted size of the private cache, a converted size of the shared cache, and a converted size of the cache memory.

The converted size of the private cache may be a size in which the private cache is reduced based on a minimum value of the private cache required for execution of an innermost loop representing an innermost looping statement among nested looping statements of a program used in the simulation, in response to the first task being processed using the size of the private cache, a ratio between cache memory usage required for processing the first task and cache memory usage required for processing the second task, and the private cache.

The converted size of the shared cache may be a size in which the shared cache is reduced based on a minimum value of the shared cache required for execution of an innermost loop representing an innermost looping statement among nested looping statements of a program used in the simulation, in response to the first task being processed using the size of the shared cache, a ratio between cache memory usage required for processing the first task and cache memory usage required for processing the second task, a number of processes required for processing the first task, and the shared cache.

The converted size of the cache memory may be a size in which the cache memory is reduced based on a minimum value of the cache memory required for execution of an innermost loop representing an innermost looping statement among nested looping statements of a program used in the simulation, in response to the first task being processed using the size of the cache memory, a ratio between cache memory usage required for processing the first task and cache memory usage required for processing the second task, a number of processes required for processing the first task, and the cache memory.

Based on the simulated hardware of the first and second configurations being a cache memory, the probability may represent a hit probability in which the requested event is successful in hitting the cache memory, and the instructions, when executed by the one or more processors, may cause the simulation device to: generate an access event for accessing the cache memory, based on the hit probability and an amount of access to the cache memory; and based on an access delay to the cache memory and a maximum bandwidth to the cache memory, determine a total access delay for processing the access event as a total access delay of the amount of access to the cache memory.

The instructions, when executed by the one or more processors, may cause the computing device to: generate a pipeline of the access event by arranging the access event in a chronological order, based on a pipeline processing method; and determine a difference between a start time and an end time of the pipeline of the access event as the total access delay.

The instructions, when executed by the one or more processors, may cause the computing device to: in response to the second task being processed based on a frequency corresponding to a clock cycle used for execution of the simulated hardware having the second configuration, generate a discrete event corresponding to an event that occurs discretely; and obtain the probability for the event requested to the simulated hardware having the first configuration by simulating the simulating hardware having the second configuration for processing the generated discrete event by using a software component corresponding to the simulated hardware having the second configuration.

In another general aspect, a simulation method performed by a computing device includes: converting a first task assigned to simulated hardware having a first configuration of a simulated computing system into a second task, wherein the first task requires a first scale and a first degree of parallelism and the second task requires a second scale that is equal to the first scale and a second degree of parallelism that is less than the first degree of parallelism; obtaining a probability that the simulated hardware having the first configuration succeeds in a requested event by executing a simulation in which hardware having a second configuration that is smaller than the simulated hardware of the first configuration processes the second task; and based on the probability, based on the first scale of the first task, and based on parameter information of the simulated hardware having the first configuration, predicting a statistical performance index of the simulated hardware having the first configuration when the simulated hardware having the first configuration processes the first task.

The converting of the first task into the second task may include: converting the simulated hardware having the first configuration into the simulated hardware having the second configuration, based on a conversion ratio of the second task to the first task; converting the first scale into the second scale; and converting the first degree of parallelism into the second degree of parallelism.

Based on the simulated hardware of the first and second configurations being a cache memory, the first configuration may include a size of a private cache of the cache memory, a size of a shared cache of the cache memory, and a size of the cache memory, and the second configuration may include the size of the private cache of the cache memory, the size of the shared cache of the cache memory, a converted size of the private cache, a converted size of the shared cache, and a converted size of the cache memory.

The converted size of the private cache may be a size in which the private cache is reduced based on a minimum value of the private cache required for execution of an innermost loop representing an innermost looping statement among nested looping statements of a program used in the simulation, in response to the first task being processed using the size of the private cache, a ratio between cache memory usage required for processing the first task and cache memory usage required for processing the second task, and the private cache.

The converted size of the shared cache may be a size in which the shared cache is reduced based on a minimum value of the shared cache required for execution of an innermost loop representing an innermost looping statement among nested looping statements of a program used in the simulation, in response to the first task being processed using the size of the shared cache, a ratio between cache memory usage required for processing the first task and cache memory usage required for processing the second task, a number of processes required for processing the first task, and the shared cache.

The converted size of the cache memory may be a size in which the cache memory is reduced based on a minimum value of the cache memory required for execution of an innermost loop representing an innermost looping statement among nested looping statements of a program used in the simulation, in response to the first task being processed using the size of the cache memory, a ratio between cache memory usage required for processing the first task and cache memory usage required for processing the second task, a number of processes required for processing the first task, and the cache memory.

On response to the simulated hardware of the first and second configurations being a cache memory, the probability may represent a hit probability in which the requested event is successful in hitting the cache memory, and the simulation method may further include: generating an access event for accessing the cache memory, based on the hit probability and an amount of access to the cache memory; and based on an access delay to the cache memory and a maximum bandwidth to the cache memory, determining a total access delay for processing the access event as a total access delay of the amount of access to the cache memory.

The generating of the access event may include: generating a pipeline of the access event by arranging the access event in a chronological order, based on a pipeline processing method; and determining a difference between a start time and an end time of the pipeline of the access event as the total access delay.

The obtaining of the probability may include: in response to the second task being processed based on a frequency corresponding to a clock cycle used for execution of the simulated hardware having the second configuration, generating a discrete event corresponding to an event that occurs discretely; and obtaining the probability for the event requested to the simulated hardware having the first configuration by simulating the simulated hardware having the second configuration for processing the generated discrete event by using a software component corresponding to the simulated hardware having the second configuration.

In another general aspect, a non-transitory computer-readable storage medium stores instructions that, when executed by a processor, cause the processor to perform any of the methods.

Other features and aspects will be apparent from the following detailed description, the drawings, and the claims.

### BRIEF DESCRIPTION OF THE DRAWINGS

FIG. 1 illustrates an example of an architecture of a computing system, according to one or more embodiments.

FIG. 2 illustrates an example of a simulation method, according to one or more embodiments.

FIG. 3 illustrates an example of a simulation process of a computing device, according to one or more embodiments.

FIG. 4 illustrates an example of a simulation performed by a pipeline processing method, according to one or more embodiments.

FIG. 5 illustrates an example of a computing device, according to one or more embodiments.

FIG. 6 illustrates an example of a computing device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

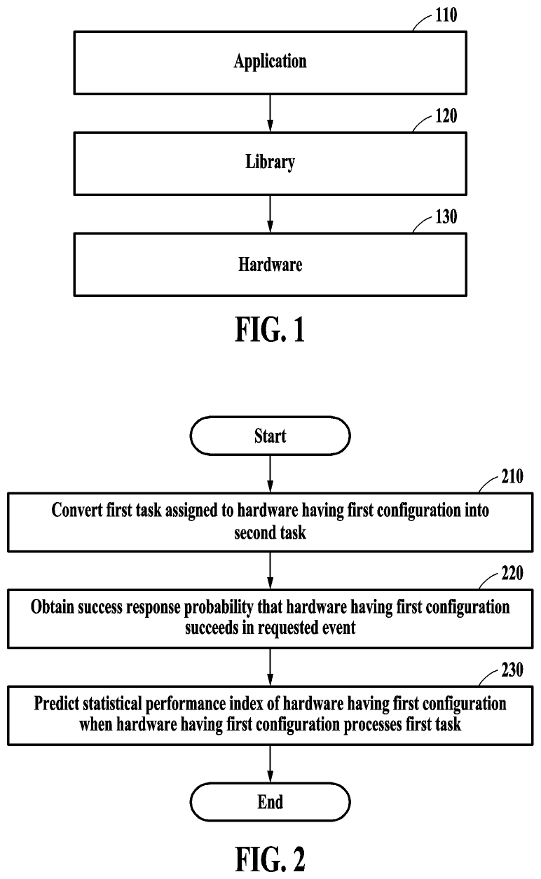

FIG. 1 illustrates an example of an architecture of a computing system, according to one or more embodiments.

Referring to FIG. 1, an architecture of a computing system may include an application 110, a library 120, and hardware 130. The application 110, the library 120, and the hardware 130 may include a top-down layer structure, as shown in FIG. 1.

The application 110 may be software or a system that applies a simulation technique to solve a particular issue or achieve a goal. The library 120 may be a mathematics library. The mathematics library may provide an interface function that may be used in the application 110. For example, the interface function may include matrix multiplication, matrix-vector multiplication, etc. The hardware 130 may be a component used for a computing operation. For example, the hardware 130 may include a processor (e.g., a processor 620 of FIG. 6) for performing calculations such as addition and multiplication, and a memory (e.g., a memory 610 of FIG. 6) in which data used for the calculations is stored.

The performance of the hardware 130 may be evaluated by running various applications or workloads on the hardware 130. In the absence of the hardware 130, the performance of the hardware 130 may be evaluated by simulating a basic function of the hardware 130 by using a simulator. A computing device (e.g., a computing device 600 of FIG. 6) may simulate the performance/execution of each function of the library 120 (e.g., a mathematics library) in the hypothetical hardware 130. The application 110 may be diverse, and the library 120 may be stably used by multiple applications 110. When the application 110 is simulated on the computing device (the device that performs the simulation), the application 110 may call separately different functions in the mathematics library. The simulation-performing computing device may model processing of the separately called functions in the hypothetical hardware 130. The simulation-performing computing device may obtain the simulated processing performance of the application 110 on the entire hypothetical hardware 130 by statistically analyzing the measured performances of the respective separately called functions.

A task processed in the application 110 may be a complex task or a simple task. Whether a task is a complex task and or a simple task may depend on the scale and the degree of parallelism of the task inputted to the application 110. For example, a complex task may be one with a high degree of parallelism and a large scale, and a simple task may be one with a low degree of parallelism and a small scale. A measurement (size) of a task's scale may be determined by different evaluation methods for each application 110. For example, the measured size of a task's scale may be determined based on the size of a matrix or the amount of memory used for matrix operations. The scale of a task inputted to the application 110 may determine/control the size of an input parameter of a mathematics library interface/function called by the application 110. For example, a task's scale may represent the size of the matrix used in matrix multiplication.

FIG. 2 illustrates an example of a simulation method, according to one or more embodiments.

Operations of the simulation method may be performed by the computing device 600 of FIG. 6.

In operation 210, the simulation-performing computing device may convert a first task assigned to hardware having a first configuration into a second task. The first task and the second task are tasks processed by a hardware device. The first task may require a first scale and a first degree of parallelism. In contrast, the second task may require (i) a second scale that is less than or equal to the first scale and may require (ii) a second degree of parallelism that is less than or equal to the first degree of parallelism. Hereinafter, the first task may be referred to as a complex task and the second task may be referred to as a simple task.

The computing device may generate the first task by using a benchmark test program. For example, the computing device may use the benchmark test program to generate the first task of various scales and degrees of parallelism for various applications.

The computing device may convert the first task of various scales and degrees of parallelism into the second task of a smaller scale than the scale of the first task and a lower degree of parallelism than the degree of parallelism of the first task.

Scale may be determined by various measurement standards. When matrix multiplication is performed, the scale of a task may represent the size of matrices and/or the total amount of memory required for a matrix multiplication operation of the matrices. For example, the computing device may convert a task of multiplying two matrices with a degree of parallelism of 8 and a size/scale of 1,024 into an task of multiplying two matrices with a degree of parallelism of 4 and a size/scale of 512. In a matrix multiplication task, the scale may represent the amount of memory access required for the matrix multiplication operation.

The degree of parallelism may represent the number of processes (or threads) used to solve the task. For example, a complex task may have a high degree of parallelism where the number of processes is large, and a simple task may have low degree of parallelism where the number of processes is equal to or less than the number of processes of the complex task. The degree of parallelism and/or the number of processes in a task may be specified as input parameter(s) according to which the benchmark test program generates the task. For example, the degree of parallelism of a complex task may be greater than 1 and the degree of parallelism of a simple task may be 1.

The computing device, based on a conversion ratio of the second task to the first task, may (i) convert the hypothetical/modeled hardware having the first configuration into hypothetical/modeled hardware having a second configuration, may (ii) convert the first scale into the second scale, and may (iii) convert the first degree of parallelism into the second degree of parallelism.

When the simulated hardware is a cache memory, for example having a private cache and a shared cache, the first configuration may include the size of the private cache, the size of the shared cache, and the size of the cache memory, and the second configuration may include the size of the private cache, the size of the shared cache, the converted size of the private cache, the converted size of the shared cache, and the converted size of the cache memory.

The converted size of the private cache may be the size to which the private cache is reduced, and the reduction may be based on (i) the pre-converted size of the private cache, (ii) a ratio between cache memory usage required for processing the first task and cache memory usage required for processing the second task, and (iii) the minimum value of the size of the private cache that is required for execution of an innermost loop. The innermost loop may be the innermost repetitive/looping statement among nested repetitive/looping statements of a program used in the simulation when the first task is processed using the private cache.

For example, the converted size of the private cache may be the larger of (i) the original size of the private cache divided by a ratio (the ratio between cache memory usage required for processing the first task and cache memory usage required for processing the second task) and (ii) the minimum value of the private cache required for execution of the innermost loop. The converted size of the private cache may be computed with code/instructions analogous to Equation 1.

$$LpSize = Max ( \frac{OriginalLpSize}{MemoryRatio} , MinThresholdLpSize ) \qquad Equation 1$$

In Equation 1, LpSize represents the converted size of the private cache, OriginalLpSize represents the original (pre-conversion) size of the private cache, MemoryRatio represents the ratio between the amount of the cache memory required for processing the first task and the amount of the cache memory required for processing the second task, and MinThresholdLpSize represents the minimum size value of the private cache required for execution of the innermost loop.

Regarding the converted size of the shared cache, that size may be the size to which the shared cache is reduced, and that reduction may be based on (i) the original size of the shared cache, (iii) the ratio between the cache memory usage required for processing the first task and the cache memory usage required for processing the second task, (iii) the number of processes required for processing the first task, and (iv) the minimum value of the shared cache required for execution of the innermost loop. The innermost loop may be the innermost repetitive/looping statement among multiple/nested repetitive/looping statements of a program used in the simulation when the first task is processed using the shared cache. For example, the converted size of the shared cache may be the larger of (i) the size of the shared cache divided by a ratio between the amount of the cache memory required for processing the first task and the amount of the cache memory required for processing the second task and the minimum size value of the shared cache required for execution of the innermost loop. The converted size of the shared cache may be computed with code/instructions configured analogously to Equation 2 below.

Regarding the converted size of the cache memory, that size may be the size to which the cache memory is reduced, and that reduction may be based on the (i) size of the cache memory, (ii) the ratio between the cache memory usage required for processing the first task and the cache memory usage required for processing the second task, (ii) the number of processes required for processing the first task, and (iii) the minimum value of the cache memory required for execution of the innermost loop. The innermost loop may be the innermost repetitive/looping statement among multiple/nested repetitive/looping statements of a program used in the simulation when the first task is processed using the cache memory. For example, the converted size of the cache memory may be a larger value among the size in which the size of the cache memory is divided by a ratio between the amount of the cache memory required for processing the first task and the amount of the cache memory required for processing the second task and the minimum value of the cache memory required for execution of the innermost loop. The converted size of the cache memory may be computed with code/instructions configured analogously to Equation 2.

$$\frac{Ls}{mSize} = Max ( \frac{\frac{OriginalLs}{mSize}}{NumberOfProcess * MemoryRatio} , \frac{MinThresholdLs}{mSize} ) \qquad Equation 2$$

In Equation 2,

$$\frac{Ls}{mSize}$$

represents the converted size of the shared cache or the converted size of the cache memory, NumberOfProcess represents the number of multiple processes in the first task, MemoryRatio represents the ratio between the amount of the cache memory required for processing the first task and the amount of the cache memory required for processing the second task, and

$$\frac{MinThresholdLs}{mSize}$$

represents the minimum size value required of the shared cache for execution of the innermost loop or the minimum value of the cache memory required for execution of the innermost loop. NumberOfProcess may be 1 or more and MemoryRatio may be 1 or more. The size of a cache and the size of the cache memory represent the size of a storage space of the cache or the cache memory.

A structure of the cache memory of the computing system may include a first level cache L1, a second level cache L2, a third level cache L3, and a cache memory Lm. L1 and L2 may be private caches and may each be included independently in a single processor. L3 may be a shared cache that may be accessed by multiple processors. When sizes of L1, L2, L3, and Lm are OriginalL1Size, OriginalL2Size, OriginalL3Size, and OriginalLmSize, respectively, the sizes thereof may be converted as described next. Incidentally, the conversion may include a conversion from the high degree of parallelism to the low degree of parallelism and a conversion from the large-scale task to the small-scale task.

The conversion of the size of the cache memory in a single dimension (a degree of parallelism or a task scale) may be performed with code/instructions configured analogously to Equations 3 to 6 and 7 to 11 below.

(1) The conversion from a high degree of parallelism to a low degree of parallelism (or the conversion from multiple processes to a single process)

$$L 1 Size = OriginalL 1 Size \qquad Equation 3$$

$$L 2 Size = OriginalL 2 Size \qquad Equation 4$$

$$L 3 Size = \frac{OriginalLmSize}{NumberOfProcess} \qquad Equation 5$$

$$LmSize = \frac{OriginalLmSize}{NumberOfProcess} \qquad Equation 6$$

In Equations 3 to 6, NumberOfProcess represents the number of multiple processes or the high degree of parallelism, OriginalL1Size, OriginalL2Size, OriginalL3Size, and OriginalLmSize represent the sizes of L1, L2, L3, and Lm, respectively, and L1Size, L2Size, L3Size, and LmSize represent a converted L1 size, a converted L2 size, a converted L3 size, and a converted Lm size, respectively.

(2) The conversion from the large-scale task to the small-scale task

The conversion of hardware sizes of L1, L2, L3 and Lm may be performed with code/instructions configured as per Equations 7 to 11.

$$L 1 {Size}^{′} = Max ( \frac{OriginalL 1 Size}{MemoryRatio} , MinThresholdL 1 Size ) \qquad Equation 7$$

$$L 2 {Size}^{′} = Max ( \frac{OriginalL 2 Size}{MemoryRatio} , MinThresholdL 2 Size ) \qquad Equation 8$$

$$L 3 {Size}^{′} = Max ( \frac{OriginalL 3 Size}{MemoryRatio} , MinThresholdL 3 Size ) \qquad Equation 9$$

$${LmSize}^{′} = Max ( \frac{OriginalLmSize}{MemoryRatio} , MinThresholdLmSize ) \qquad Equation 10$$

$$MemoryRatio = \frac{UsedMemLargeProblem}{UsedMemSmallProblem} \qquad Equation 11$$

In Equations 7 to 11, L1Size′, L2Size′, L3Size′, and LmSize′ represent the converted hardware sizes of L1, L2, L3, and Lm, respectively. UsedMemLargeProblem represents the amount of the cache memory used when processing the large-scale task, UsedMemSmallProblem represents the amount of the cache memory used when processing the small-scale task, and MemoryRatio represents the ratio of the amount of the cache memory used when processing the small-scale task to the amount of the cache memory used when processing the large-scale task.

MinThresholdL1Size, MinThresholdL2Size, MinThresholdL3Size and MinThresholdLmSize represent the minimum storage space of L1, the minimum storage space of L2, the minimum storage space of L3, and the minimum storage space of Lm required to execute the innermost loop in each application, respectively. The innermost loop is the innermost repetitive/looping statement among multiple/nested repetitive/looping statements included in an application program.

The conversion of the size of the cache memory in two dimensions (a degree of parallelism and/or a task scale) may be performed by code/instructions configured analogously to Equations 12 to 15 below.

$$L 1 Size = Max ( \frac{OriginalL 1 Size}{MemoryRatio} , MinThresholdL 1 Size ) \qquad Equation 12$$

$$L 2 Size = Max ( \frac{OriginalL 2 Size}{MemoryRatio} , MinThresholdL 2 Size ) \qquad Equation 13$$

$$L 3 Size = Max ( \frac{OriginalL 3 Size}{NumberOfProcess * MemoryRatio} , MinThresholdL 3 Size ) \qquad Equation 14$$

$$LmSize = Max ( \frac{OriginalLmSize}{NumberOfProcess * MemoryRatio} , MinThresholdLmSize ) \qquad Equation 15$$

In Equations 12 to 15, L1Size, L2Size, L3Size, and LmSize represent the converted L1 size, the converted L2 size, the converted L3 size, and the converted Lm size, respectively, OriginalL1Size, OriginalL2Size, OriginalL3Size, and OriginalLmSize represent the sizes of L1, L2, L3, and Lm, respectively, MemoryRatio represents the ratio of the amount of the cache memory used when processing the small-scale task to the amount of the cache memory used when processing the large-scale task, NumberOfProcess represents the number of multiple processes or the high degree of parallelism, and MinThresholdL1Size, MinThresholdL2Size, MinThresholdL3Size, and MinThresholdLmSize represent the minimum storage space of L1, the minimum storage space of L2, the minimum storage space of L3, and the minimum storage space of Lm required to execute the innermost loop in each application, respectively.

When a hardware configuration (e.g., a cache size and/or a memory size) is reduced according to the conversion ratio between the complex and simple tasks, a statistical probability value for processing the simple task on hardware with a reduced configuration may approach a statistical probability value for processing the complex task on entire (non-reduced) hardware. Through this process, performance of hardware for processing the complex task may be estimated by simulating the simple task.

The conversion ratio between the complex and simple tasks is not limited, and the hardware configuration of the computing device may be reduced based on a set conversion ratio (e.g., a conversion ratio preset by a user or a conversion ratio set by a rule).

In operation 220, the computing device may obtain a success response probability that the hardware having the first configuration succeeds in a requested event. This may be done by executing a simulation in which hardware having a second configuration (that is smaller than the hardware of the first configuration) processes the second task.

The computing device may convert tasks (e.g., complex tasks) with different task scales and different degrees of parallelism into a task (e.g., a simple task) with the same scale and the same degree of parallelism (e.g., the same small-scale task and the same low degree of parallelism), and may convert the hardware configuration at the same ratio as the conversion ratio at which the complex task is converted into the simple task. Statistical probability information of the simple task may be obtained through a simulation on the converted hardware, and probability information of the complex task (e.g., a large-scale task and an task of high degree of parallelism). For example, the computing device may estimate the success probability response obtained through a simulation of the hardware having the second configuration processing the second task as the probability that the hardware having the first configuration succeeds in a request event. The request event may represent an actual hardware event that occurs in different situations. For example, a database may be called when an application needs to calculate matrix multiplication of size 1,024 in 8 processes simultaneously. When the calculation is performed through an interface of the database, 1,024*1,024*1,024 memory access request events may occur at 8 degrees of parallelism.

The computing device may generate a discrete event corresponding to an event that occurs discretely and that occurs when the second task is processed based on a frequency corresponding to a hypothetical clock cycle used for execution of the hypothetical hardware having the second configuration. The computing device may obtain the success probability response for the event requested to the hardware having the first configuration by simulating the hardware having the second configuration for processing the generated discrete event by using a software component corresponding to the hardware having the second configuration. When the hardware is a cache memory, for example, the requested event may represent a request for the processor to read or write data to/from a memory at a specified location. When the hardware is a gateway or a router, for example, the requested event may represent a request for a network link to receive or transmit a network data packet for a specified network address. When the hardware is a cache memory, the success probability response may represent a hit probability of the cache memory. The hardware is not limited to the cache memory, and when the hardware is a gateway or a router, the success probability response may represent the probability that the gateway or the router successfully transmits or receives the data packet.

In operation 230, the computing device may predict a statistical performance index of the hardware having the first configuration when the hardware having the first configuration processes the first task. The computing device may predict the statistical performance index of the hardware having the first configuration when the hardware having the first configuration processes the first task, based on the success probability response, the first scale of the first task, and parameter information of the hardware having the first configuration. The statistical performance index may represent expected performance of a function called when the application is executed on hardware with a particular configuration (e.g., the hardware having the first configuration).

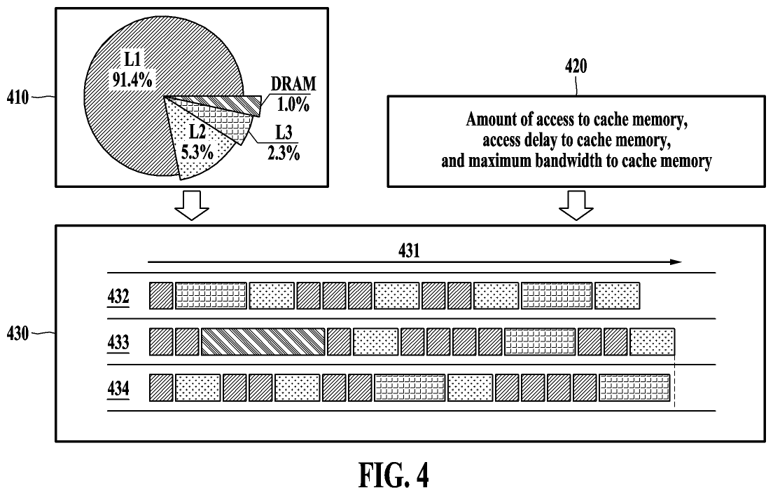

When the hardware is a cache memory, the success response probability may represent a hit probability in which the requested event is successful in the cache memory (a hit occurs). The computing device may generate an access event for accessing the cache memory, based on the hit probability and the amount of access to the cache memory (e.g., an amount of data accessed), and based on an access delay to the cache memory and the maximum bandwidth to the cache memory, may determine a total access delay for processing the access event as a total access delay of the amount of access to the cache memory. For example, the computing device may generate a pipeline of access events by arranging the access events in a chronological order, based on a pipeline processing method, and may determine a difference between the start time and the end time of the pipeline of the access events as the total access delay. A method of determining the total access delay based on a pipeline processing method is described in detail with reference to FIG. 4.

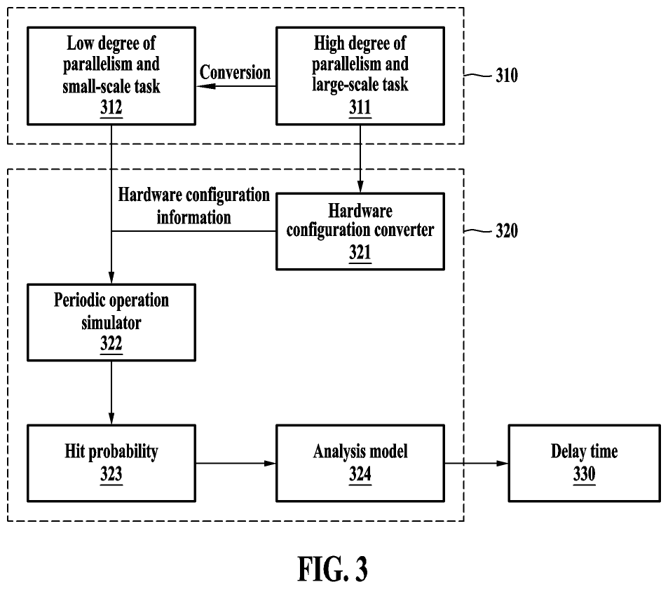

FIG. 3 illustrates an example of a simulation process of a computing device, according to one or more embodiments.

Referring to FIG. 3, a computing device (e.g., the computing device of FIG. 6) may estimate a delay time by performing a simulation using an application layer 310 and a hardware layer 320.

The computing device may convert a high degree of parallelism and large-scale task 311 into a low degree of parallelism and small-scale task 312 at the application layer 310. The description of the computing device converting the high degree of parallelism and large-scale task 311 into the low degree of parallelism and small-scale task 312 provided with reference to FIG. 1 is generally applicable.

The simulation-performing computing device may reduce the size of a cache memory at the hardware layer 320. For example, the computing device may reduce the size of the cache memory by using a hardware configuration converter 321. To estimate a cache memory hit probability of a complex task (a large-scale task, a high degree of parallelism) by simulating a simple task (a small-scale task, a low degree of parallelism), the computing device may adjust a relationship between an application (or an task) and a hardware configuration. The computing device may reduce the hardware configuration (e.g., a cache and a memory) to the same ratio, based on a conversion ratio (or a difference ratio) between the complex task and the simple task, by using the hardware configuration converter 321.

The computing device may predict a hit probability 323 of the cache memory by using a periodic operation simulator 322. The periodic operation simulator 322 may predict the hit probability 323 of the cache memory, based on hardware configuration information of the hardware converted by the hardware configuration converter 321 and based on the low degree of parallelism and small-scale task 312. For example, the periodic operation simulator 322 may perform a simulation on the application in the hardware, based on a discrete event and a clock frequency. The periodic operation simulator 322 may include a periodic operation simulator of a structural simulation toolkit (SST).

The computing device may estimate a delay time 330 by using an analysis model 324. For example, the computing device may estimate the total delay time 330 of the cache memory when processing the complex task by using the analysis model 324 (or a probability memory model) and the hit probability 323 of the cache memory output from the periodic operation simulator 322. The analysis model 324 may generate access events that access the cache memory, based on the cache memory hit probability and the amount of cache memory access (e.g., the amount of cache memory access corresponding to the complex task) in which the application accesses the cache memory. The delay time 330 of each access event is the same as the delay time 330 of the access of the cache memory. The access events may be arranged in a chronological order according to a pipeline processing method. When the access events are arranged, an access bandwidth may not exceed the maximum bandwidth. When processing of all access events is completed, the pipeline processing method may be terminated. The computing device may estimate an end time of the pipeline processing method as the delay time 330 of a total memory access.

The computing device may improve accuracy and expandability of the analysis model 324 and may increase accuracy of the simulation by inputting probability information of the application for the hardware to the analysis model 324. The computing device may estimate a statistical performance index of the cache memory when processing the complex task with the cache memory, based on the analysis model 324 using the cache memory hit probability, input of the complex task (or the amount of memory access of the complex task), and based on unique parameter information of the hardware (e.g., a cache memory access delay time and the maximum memory bandwidth).

FIG. 4 illustrates an example of a simulation performed by a pipeline processing method, according to one or more embodiments.

Referring to FIG. 4, a computing device (e.g., a computing device of FIG. 6) may perform a simulation using a pipeline processing method 430, based on general software information 410 and hardware information 420. The pipeline processing method 430 may include a first pipeline 432, a second pipeline 433, and a third pipeline 434. The first pipeline 432, the second pipeline 433, and the third pipeline 434 may include access events that access a cache memory and are arranged in a chronological order 431. A delay time (e.g., the delay time 330 of FIG. 3) of each access event is the same as the delay time 330 of the access of the cache memory. When all access events are processed in the first pipeline 432, the second pipeline 433, and the third pipeline 434, the pipeline processing method may be terminated. The computing device may estimate an end time of the pipeline processing method as the delay time 330 of a total memory access.

The general software information 410 and the hardware information 420 may include information indicating the amount of access to the cache memory, the access delay to the cache memory, and the maximum bandwidth to the cache memory. The (maximum) bandwidth of the cache memory may be included in unique parameter information of the cache memory and may be determined in a phase of designing the cache memory.

Since the computing device uses the general software information 410, the hardware information 420, and a hit probability (e.g., the hit probability 323 of FIG. 3) output from a periodic operation simulator (e.g., the periodic operation simulator 322 of FIG. 3) as inputs to an analysis model, the computing device may simulate access situations of various applications in the cache memory and may improve expandability and accuracy of the simulation.

The computing device may efficiently and accurately simulate performance of an application at a variety of task scales and degrees of parallelism. When the hardware is a cache memory, the computing device may reduce a complex task to a simple task and may reduce the size of the cache memory at the same ratio as the ratio at which the complex task is reduced to the simple task. The computing device may predict the hit probability (e.g., the hit probability 323 of FIG. 3) of the cache memory of the simple task in the reduced cache memory configuration and based on the delay time obtained from the analysis model to which the hit probability of the cache memory of the simple task, the general software information 410, and the hardware information 420 are input, may estimate the performance of the application.

Since the computing device may simulate the complex task by converting (e.g., reducing) the complex task into the simple task and converting (e.g., reducing) large-scale hardware into small-scale hardware, the computing device may be used to simulate a complex application when executed on the large-scale hardware.

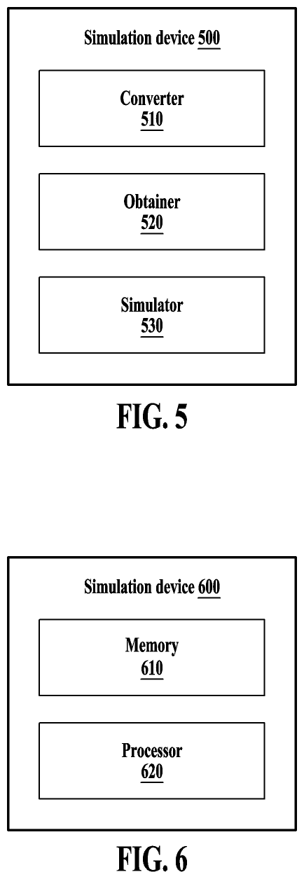

FIG. 5 illustrates an example of a computing device, according to one or more embodiments.

Referring to FIG. 5, a computing device 500 may include a converter 510, an obtainer 520, and a simulator 530.

The converter 510 may convert a first task assigned to hardware having a first configuration into a second task. The first task may require a first scale and a first degree of parallelism, and the second task may require a second scale that is less than or equal to the first scale and a second degree of parallelism that is less than or equal to the first degree of parallelism. Since the description of the converter 510 converting the first task into the second task is provided in operation 210 of FIG. 2, a repeated description thereof is omitted herein.

The obtainer 520 may obtain a success response probability that the hardware having the first configuration succeeds in a requested event. The obtainer 520 may obtain the success response probability that the hardware having the first configuration succeeds in the requested event by executing a simulation in which hardware having a second configuration that is smaller than the hardware of the first configuration processes the second task. When the hardware is a cache memory, the success response probability may represent a hit probability of the cache memory.

The obtainer 520 may generate a discrete event with a clock cycle as a frequency when the hardware having the second configuration is executed. The generated discrete event may correspond to a discrete event that occurs when the hardware having the second configuration processes the second task. The obtainer 520 may obtain the success response probability for the requested event requested to the hardware having the first configuration by simulating the hardware having the second configuration for processing the generated discrete event by using a software component corresponding to the hardware having the second configuration. Since the description of obtaining the success response probability is provided in operation 220 of FIG. 2, a repeated description thereof is omitted herein.

The simulator 530 may estimate a total access delay of the cache memory, based on the cache memory hit probability and the amount of access to the cache memory. For example, the simulator 530 may generate an access event for accessing the cache memory, based on the cache memory hit probability and the amount of access to the cache memory. The simulator 530 may estimate the total access delay for processing the generated access event as the total access delay of the cache memory, based on an access delay of the cache memory and the maximum bandwidth of the cache memory. For example, the simulator 530 may arrange access events in a chronological order, based on a pipeline processing method, may configure a pipeline using the access events, and may estimate a difference between the start time and the end time of the pipeline as the total access delay. Since the obtaining of the total access delay based on a simulation is described in detail with reference to FIG. 4, a repeated description thereof is omitted herein.

A non-transitory computer-readable storage medium may store instructions that, when executed by a processor, cause the processor to perform the method performed by the computing device 500. A program in the non-transitory computer-readable storage medium may run in an environment deployed in a computer device such as a client, a host, a proxy device, a server, and the like. Computer programs and any associated data, data files, and data structures may be distributed over network-coupled computer systems so that the computer programs and any associated data, data files, and data structures may be stored, accessed, and executed in a distributed fashion by one or more processors or computers.

FIG. 6 illustrates an example of a computing device, according to one or more embodiments.

Referring to FIG. 6, a computing device 600 (e.g., the computing device 500) may include a memory 610 and a processor 620.

The memory 610 may store instructions that the processor 620 may perform. The memory 610 may store instructions executable by the processor 620. When executed by the processor 620, the instructions executable by the processor 620 may cause the processor 620 to perform a simulation method of the computing device 600. The memory 610 may be integrated with the processor 620. For example, random-access memory (RAM) or flash memory may be arranged in an integrated circuit (IC) microprocessor. In addition, the memory 610 may include a separate device, such as a storage device that may be used by an external disk drive, a storage array, or a database system. The memory 610 and the processor 620 may be operatively integrated or may communicate with each other through an input/output (I/O) port or a network connection so that the processor 620 may read a file stored in the memory 610. The memory 610 may be a non-transitory computer-readable storage medium that stores instructions, and when the instructions are executed by the processor 620, the instructions stored in the memory 610 may prompt at least one processor 620 to execute the image processing method or an image processing model.

The non-transitory computer-readable storage medium may include read-only memory (ROM), programmable ROM (PROM), electrically erasable PROM (EEPROM), RAM, dynamic RAM (DRAM), static RAM (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, BLU-RAY or optical disk memory, hard disk drive (HDD), solid-state drive (SSD), card memory (e.g., a multimedia card, a secure digital (SD) card, or an extreme digital (XD) card), magnetic tape, floppy disk, a magneto-optical data storage device, an optical data storage device, and other devices (but not a signal per se).

For example, the processor 620 may execute the instructions stored in the memory 610. The processor 620 may include a central processing unit (CPU), a graphics processing unit (GPU), a neural network processing unit (NPU), a media processing unit (MPU), a data processing unit (DPU), a vision processing unit (VPU), a video processor, an image processor, a display processor, a microprocessor, a processor core, a multi-core processor, an ASIC, a field programmable gate array (FPGA), or any combination thereof.

The instructions, when executed by the processor 620, cause the computing device 600 to convert a first task assigned to hardware having a first configuration of the computing system into a second task, obtain a success response probability that the hardware having the first configuration succeeds in a requested event by executing a simulation in which hardware having a second configuration that is smaller than the hardware of the first configuration processes the second task, and based on the success response probability, a first scale of the first task, and parameter information of the hardware having the first configuration, predict a statistical performance index of the hardware having the first configuration when the hardware having the first configuration processes the first task. The first task processed by the processor 620 may require the first scale and a first degree of parallelism, and the second task may require a second scale that is less than or equal to the first scale and a second degree of parallelism that is less than or equal to the first degree of parallelism.

The instructions, when executed by the processor 620, cause the computing device 600 to convert the hardware having the first configuration into the hardware having the second configuration, based on a conversion ratio of the second task to the first task, convert the first scale into the second scale, and convert the first degree of parallelism into the second degree of parallelism.

When the hardware is a cache memory, the first configuration may include the size of a private cache of the cache memory, the size of a shared cache of the cache memory, and the size of the cache memory, and the second configuration may include the size of the private cache of the cache memory, the size of the shared cache of the cache memory, the converted size of the private cache, the converted size of the shared cache, and the converted size of the cache memory.

The converted size of the private cache may be, in response to the first task being processed using the size of the private cache, a ratio between cache memory usage required for processing the first task and cache memory usage required for processing the second task, and the private cache, the size in which the private cache is reduced based on the minimum value of the private cache required for execution of the innermost loop representing the innermost repetitive statement among multiple repetitive statements of a program used in the simulation. The converted size of the shared cache may be, in response to the first task being processed using the size of the shared cache, a ratio between cache memory usage required for processing the first task and cache memory usage required for processing the second task, the number of processes required for processing the first task, and the shared cache, the size in which the shared cache is reduced based on the minimum value of the shared cache required for execution of the innermost loop representing the innermost repetitive statement among multiple repetitive statements of a program used in the simulation.

The converted size of the cache memory may be, in response to the first task being processed using the size of the cache memory, a ratio between cache memory usage required for processing the first task and cache memory usage required for processing the second task, the number of processes required for processing the first task, and the cache memory, the size in which the cache memory is reduced based on the minimum value of the cache memory required for execution of the innermost loop representing the innermost repetitive statement among multiple repetitive statements of a program used in the simulation.

In response to the hardware being a cache memory, the success response probability may represent a hit probability in which the requested event is successful in the cache memory, and the instructions, when executed by the processor 620, cause the computing device 600 to generate an access event for accessing the cache memory, based on the hit probability and the amount of access to the cache memory, and based on an access delay to the cache memory and the maximum bandwidth to the cache memory, determine a total access delay for processing the access event as a total access delay of the amount of access to the cache memory.

The instructions, when executed by the processor 620, cause the computing device 600 to generate a pipeline of the access event by arranging the access event in a chronological order, based on a pipeline processing method, and determine a difference between the start time and the end time of the pipeline of the access event as the total access delay.

The instructions, when executed by the processor 620, cause the computing device 600 to, in response to the second task being processed based on a frequency corresponding to a clock cycle used for execution of the hardware having the second configuration, generate a discrete event corresponding to an event that occurs discretely and obtain the success response probability for the event requested to the hardware having the first configuration by simulating the hardware having the second configuration for processing the generated discrete event by using a software component corresponding to the hardware having the second configuration.

The examples described herein may be implemented by using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is singular; however, one of ordinary skill in the art will appreciate that a processing device may include a plurality of processing elements and a plurality of types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored in a non-transitory computer-readable recording medium.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical discs; and hardware devices that are specifically configured to store and perform program instructions, such as read-only memory (ROM), random access memory (RAM), flash memory, and the like (but not signals per se). Examples of program instructions include both machine code, such as one produced by a compiler, and files containing higher-level code that may be executed by the computer using an interpreter.

The computing apparatuses, the electronic devices, the processors, the memories, the displays, the information output system and hardware, the storage devices, and other apparatuses, devices, units, modules, and components described herein with respect to FIGS. 1-6 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A computing device for simulating a computing system, the computing device comprising:
a memory storing instructions; and
one or more processors configured to execute the instructions,
wherein the instructions, when executed by the one or more processors, cause the computing device to:
convert a first task assigned to simulated hardware having a first configuration of the simulated computing system into a second task, wherein the first task requires a first scale and a first degree of parallelism and the second task requires a second scale that is less than the first scale and a second degree of parallelism that is less than the first degree of parallelism;
obtain a probability of the simulated hardware having the first configuration succeeding in a requested event, the obtaining performed by executing a simulation in which simulated hardware having a second configuration that is smaller than the simulated hardware having the first configuration processes the second task; and
based on the probability, based on the first scale of the first task, and based on parameter information of the simulated hardware having the first configuration, predict a statistical performance index of the simulated hardware having the first configuration when the simulated hardware having the first configuration processes the first task.

2. The simulation device of claim 1, wherein
the instructions, when executed by the one or more processors, cause the computing device to:
convert the simulated hardware having the first configuration into the simulated hardware having the second configuration, based on a conversion ratio of the second task to the first task;
convert the first scale into the second scale; and
convert the first degree of parallelism into the second degree of parallelism.

3. The computing device of claim 1, wherein,
based on the simulated hardware of the first and second configurations being a cache memory,
the first configuration comprises a size of a private cache of the cache memory, a size of a shared cache of the cache memory, and a size of the cache memory, and
the second configuration comprises the size of the private cache of the cache memory, the size of the shared cache of the cache memory, a converted size of the private cache, a converted size of the shared cache, and a converted size of the cache memory.

4. The simulation device of claim 3, wherein
the converted size of the private cache is a size in which the private cache is reduced based on a minimum value of the private cache required for execution of an innermost loop representing an innermost looping statement among nested looping statements of a program used in the simulation, in response to the first task being processed using the size of the private cache, a ratio between cache memory usage required for processing the first task and cache memory usage required for processing the second task, and the private cache.

5. The simulation device of claim 3, wherein
the converted size of the shared cache is a size in which the shared cache is reduced based on a minimum value of the shared cache required for execution of an innermost loop representing an innermost looping statement among nested looping statements of a program used in the simulation, in response to the first task being processed using the size of the shared cache, a ratio between cache memory usage required for processing the first task and cache memory usage required for processing the second task, a number of processes required for processing the first task, and the shared cache.

6. The simulation device of claim 3, wherein
the converted size of the cache memory is a size in which the cache memory is reduced based on a minimum value of the cache memory required for execution of an innermost loop representing an innermost looping statement among nested looping statements of a program used in the simulation, in response to the first task being processed using the size of the cache memory, a ratio between cache memory usage required for processing the first task and cache memory usage required for processing the second task, a number of processes required for processing the first task, and the cache memory.

7. The simulation device of claim 1, wherein,
based on the simulated hardware of the first and second configurations being a cache memory,
the probability represents a hit probability in which the requested event is successful in hitting the cache memory, and
the instructions, when executed by the one or more processors, cause the simulation device to:
generate an access event for accessing the cache memory, based on the hit probability and an amount of access to the cache memory; and
based on an access delay to the cache memory and a maximum bandwidth to the cache memory, determine a total access delay for processing the access event as a total access delay of the amount of access to the cache memory.

8. The simulation device of claim 7, wherein
the instructions, when executed by the one or more processors, cause the computing device to:
generate a pipeline of the access event by arranging the access event in a chronological order, based on a pipeline processing method; and
determine a difference between a start time and an end time of the pipeline of the access event as the total access delay.

9. The simulation device of claim 1, wherein
the instructions, when executed by the one or more processors, cause the computing device to:
in response to the second task being processed based on a frequency corresponding to a clock cycle used for execution of the simulated hardware having the second configuration, generate a discrete event corresponding to an event that occurs discretely; and
obtain the probability for the event requested to the simulated hardware having the first configuration by simulating the simulating hardware having the second configuration for processing the generated discrete event by using a software component corresponding to the simulated hardware having the second configuration.

10. A simulation method performed by a computing device, the simulation method comprising:
converting a first task assigned to simulated hardware having a first configuration of a simulated computing system into a second task, wherein the first task requires a first scale and a first degree of parallelism and the second task requires a second scale that is equal to the first scale and a second degree of parallelism that is less than the first degree of parallelism;
obtaining a probability that the simulated hardware having the first configuration succeeds in a requested event by executing a simulation in which hardware having a second configuration that is smaller than the simulated hardware of the first configuration processes the second task; and
based on the probability, based on the first scale of the first task, and based on parameter information of the simulated hardware having the first configuration, predicting a statistical performance index of the simulated hardware having the first configuration when the simulated hardware having the first configuration processes the first task.

11. The simulation method of claim 10, wherein
the converting of the first task into the second task comprises:
converting the simulated hardware having the first configuration into the simulated hardware having the second configuration, based on a conversion ratio of the second task to the first task;
converting the first scale into the second scale; and
converting the first degree of parallelism into the second degree of parallelism.

12. The simulation method of claim 10, wherein,
based on the simulated hardware of the first and second configurations being a cache memory,
the first configuration comprises a size of a private cache of the cache memory, a size of a shared cache of the cache memory, and a size of the cache memory, and
the second configuration comprises the size of the private cache of the cache memory, the size of the shared cache of the cache memory, a converted size of the private cache, a converted size of the shared cache, and a converted size of the cache memory.

13. The simulation method of claim 12, wherein
the converted size of the private cache is a size in which the private cache is reduced based on a minimum value of the private cache required for execution of an innermost loop representing an innermost looping statement among nested looping statements of a program used in the simulation, in response to the first task being processed using the size of the private cache, a ratio between cache memory usage required for processing the first task and cache memory usage required for processing the second task, and the private cache.

14. The simulation method of claim 12, wherein
the converted size of the shared cache is a size in which the shared cache is reduced based on a minimum value of the shared cache required for execution of an innermost loop representing an innermost looping statement among nested looping statements of a program used in the simulation, in response to the first task being processed using the size of the shared cache, a ratio between cache memory usage required for processing the first task and cache memory usage required for processing the second task, a number of processes required for processing the first task, and the shared cache.

15. The simulation method of claim 12, wherein
the converted size of the cache memory is a size in which the cache memory is reduced based on a minimum value of the cache memory required for execution of an innermost loop representing an innermost looping statement among nested looping statements of a program used in the simulation, in response to the first task being processed using the size of the cache memory, a ratio between cache memory usage required for processing the first task and cache memory usage required for processing the second task, a number of processes required for processing the first task, and the cache memory.

16. The simulation method of claim 10, wherein,
in response to the simulated hardware of the first and second configurations being a cache memory,
the probability represents a hit probability in which the requested event is successful in hitting the cache memory, and
the simulation method further comprises:
generating an access event for accessing the cache memory, based on the hit probability and an amount of access to the cache memory; and
based on an access delay to the cache memory and a maximum bandwidth to the cache memory, determining a total access delay for processing the access event as a total access delay of the amount of access to the cache memory.

17. The simulation method of claim 16, wherein
the generating of the access event comprises:
generating a pipeline of the access event by arranging the access event in a chronological order, based on a pipeline processing method; and
determining a difference between a start time and an end time of the pipeline of the access event as the total access delay.

18. The simulation method of claim 10, wherein
the obtaining of the probability comprises:
in response to the second task being processed based on a frequency corresponding to a clock cycle used for execution of the simulated hardware having the second configuration, generating a discrete event corresponding to an event that occurs discretely; and
obtaining the probability for the event requested to the simulated hardware having the first configuration by simulating the simulated hardware having the second configuration for processing the generated discrete event by using a software component corresponding to the simulated hardware having the second configuration.

19. A non-transitory computer-readable storage medium storing instructions that, when executed by a processor, cause the processor to perform the method of claim 10.
